(19) United States
(12) Patent Application Publication
(10) Pub. No.: US 2006/0014076 A1
(43) Pub. Date: Jan. 19, 2006

(54) Non-aqueous electrolyte secondary battery

(75) Inventors: Kazunori Donoue, Kobe-shi (JP); Takao Inoue, Kobe-shi (JP); Denis Yau Wai Yu, Kobe-shi (JP); Masahisa Fujimoto, Osaka (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/181,894

(22) Filed: Jul. 15, 2005

(30) Foreign Application Priority Data
Jul. 16, 2004 (JP) 2004-209828

(51) Int. Cl. H01M 4/62; H01M 4/58

(52) U.S. Cl. 429/217; 429/231.95; 429/221; 429/223; 429/231.5; 429/224

(57) ABSTRACT

A non-aqueous electrolyte secondary battery comprises a positive electrode, a negative electrode, and a non-aqueous electrolyte. The positive electrode comprises a positive electrode mixture and a current collector, wherein the positive electrode mixture has a positive electrode active material, a binder, and a conducting agent. A lithium-containing compound having an olivine structure is used as the positive electrode active material. A copolymer of polyvinylidene fluoride, tetrafluoroethylene, and hexafluoropropylene is used as the binder. Conducting carbon powder may be used as the conducting agent. Lithium metal may be used as the negative electrode. A non-aqueous solvent in which an electrolytic salt is dissolved may be used as the non-aqueous electrolyte.

### BACKGROUND OF THE INVENTION

1. Field of the Invention

The present invention relates to non-aqueous electrolyte secondary batteries comprising a positive electrode, a negative electrode, and a non-aqueous electrolyte.

2. Description of the Background Art

Non-aqueous electrolyte secondary batteries are available today as secondary batteries having high energy density. In a non-aqueous electrolyte secondary battery, charge and discharge occur by the transfer of lithium ions between a positive electrode and a negative electrode.

In such a non-aqueous electrolyte secondary battery, in general, a complex oxide of lithium transition metals such as lithium cobaltate (LiCoO₂) is used as the positive electrode, and a carbon material that can occlude and release lithium, a lithium metal, a lithium alloy, or the like is used as the negative electrode. In addition, an organic solvent such as ethylene carbonate or diethyl carbonate in which a lithium salt such as lithium borate tetrafluoride (LiBF₄) or lithium phosphate hexafluoride (LiPF₆) is dissolved is used as the non-aqueous electrolyte.

In the case of using lithium cobaltate (LiCoO₂) as the positive electrode of such a non-aqueous electrolyte secondary battery, the production cost is expensive, since cobalt is a rare resource due to its limited reserves. Another problem with using lithium cobaltate is that if the temperature becomes higher than expected under normal usage conditions during charge, oxygen in the positive electrode is released to increase the reaction with an electrolyte, resulting in lowered thermal stability.

For this reason, the use of lithium manganate (LiMn₂O₄), lithium nickelate (LiNiO₂) and the like as positive electrode active materials as the substitutes for lithium cobaltate (LiCoO₂) is under consideration.

However, the use of lithium manganate (LiMn₂O₄) as a positive electrode material presents such problems as insufficient discharge capacity or the dissolution of manganese (Mn) in a battery at high temperature. On the other hand, the use of lithium nickelate (LiNiO₂) as a positive electrode material presents such problems as low discharge voltage.

For the reasons as discussed above, olivine-type lithium phosphates such as lithium iron phosphate (LiFePO₄) are recently attracting attention as positive electrode materials as the substitutes for lithium cobaltate (LiCoO₂).

An olivine-type lithium phosphate is a lithium-containing compound having an olivine structure, which is represented by a general formula, LiMPO₄, where M for use may be at least one metal element selected from iron (Fe), cobalt (Co), nickel (Ni), and manganese (Mn). The electrode potential of LiMPO₄ varies depending on the kind of the metal element M as the nucleus. The battery voltage can thus be arbitrarily determined by selecting the kind of the metal element M. Moreover, LiMPO₄ has a relatively high theoretical capacity from 140 mAh/g to 170 mAh/g, so that the battery capacity per unit mass can be increased. In addition, when iron (Fe) is selected as the metal element M, the production cost can substantially be reduced since iron is inexpensive due to its large production.

However, the use of an olivine-type lithium phosphate instead of lithium cobaltate (LiCoO₂) as a positive electrode active material degrades the battery characteristics. The present inventors guessed the reasons as follows.

When lithium cobaltate (LiCoO₂) is used as a positive electrode active material, since lithium cobaltate per se has a certain degree of conductivity (about 10⁻³ S/cm), if the adhesion between lithium cobaltate (LiCoO₂) and a conducting agent, between the conducting agent and a current collector, and between the current collector and lithium cobaltate (LiCoO₂) is more than a fixed level, improving the adhesion does not result in any further improvements in the battery characteristics. Hence, there is no need to improve the adhesion any more. For this reason, polytetrafluoroethylene (PTFE), polyvinylidene difluoride (PVdF), and the like that are generally used in non-aqueous electrolyte secondary batteries may be used as binders without any problems.

In contrast, the conductivity of an olivine-type lithium phosphate (about 10⁻¹⁰ S/cm) is much lower than those of lithium cobaltate (LiCoO₂), lithium manganate (LiMn₂O₄), lithium nickelate (LiNiO₂), and the like. Thus, when such an olivine-type lithium phosphate is used as a positive electrode active material, the adhesion between the olivine-type lithium phosphate and a conducting agent, between the conducting agent and a current collector, and between the current collector and olivine-type lithium phosphate must be improved to avoid significant decreases in the battery characteristics.

However, the use of the above-mentioned polytetrafluoroethylene (PTFE), polyvinylidene difluoride (PVdF) or the like as a binder does not provide sufficient adhesion for improving the electrode characteristics. Therefore, non-aqueous electrolyte secondary batteries using olivine-type lithium phosphates show significant degradation in the battery characteristics, particularly during discharge at high rate that increases the polarization.

JP 2002-110162 A describes an improved electron conductivity of a complex of LiₓFePO₄ and a carbon material as a positive electrode active material in a non-aqueous electrolyte secondary battery. This is achieved by defining the particle size of primary particles of the positive electrode active material to not more than 3.1 μm to increase the specific surface area per unit mass of the positive electrode active material.

However, a small particle size of primary particles of a positive electrode active material, as with the above-described non-aqueous electrolyte secondary battery in JP 2002-110162 A, reduces the packing density of the positive electrode, thus resulting in a lower energy density of the battery.

### SUMMARY OF THE INVENTION

An object of the invention is to provide a low-cost non-aqueous electrolyte secondary battery that allows increased capacity and increased energy density as well as good discharge characteristics during discharge at high rate.

A non-aqueous electrolyte secondary battery according to one aspect of the invention comprises a positive electrode mixture, a negative electrode, and a non-aqueous electrolyte, wherein the positive electrode mixture includes a positive electrode active material that includes a lithium-containing compound having an olivine structure, a conducting agent, and a binder, and the binder includes a copolymer of polyvinylidene fluoride, tetrafluoroethylene, and hexafluoropropylene.

The inclusion of the copolymer of polyvinylidene fluoride, tetrafluoroethylene, and hexafluoropropylene as the binder in the non-aqueous electrolyte secondary battery increases the packing density of the positive electrode mixture. This allows improved adhesion between the positive electrode active material and the conducting agent, adhesion between the conducting agent and a current collector, and adhesion between the current collector and the positive electrode active material, thereby improving the electron conductivity of the positive electrode mixture. This results in improved load characteristic of the positive electrode, and improved discharge characteristics during discharge at high rate. Moreover, a high theoretical capacity of the lithium-containing compound having the olivine structure as the positive electrode active material allows an increase in the battery capacity per unit mass. In addition, the packing density of the positive electrode mixture is increased to improve the energy density. As a result of the foregoing, the non-aqueous electrolyte secondary battery allows increased capacity and increased energy density.

The lithium-containing compound having the olivine structure may be represented by LiₓM_{1-(d+t+q+r)}D_{d}TₜQ_{q}Rᵣ(XO₄), where x, d, t, q, and r satisfy relationships of 0<x≦1; 0≦d≦1; 0≦t≦1; 0≦q≦1; and 0≦r≦1, respectively; M is at least one selected from the group consisting of iron (Fe), manganese (Mn), cobalt (Co), titanium (Ti), and nickel (Ni); X is at least one selected from the group consisting of silicon (Si), sulfur (S), phosphorus (P), and vanadium (V); D is a bivalent ion selected from the group consisting of Mg²⁺, Ni²⁺, Co²⁺, Zn²+, and Cu²⁺; T is a trivalent ion selected from the group consisting of Al³+, Ti³+, Cr³⁺, Fe³⁺, Mn³⁺, Ga³⁺, Zn³⁺, and V³⁺; Q is a quadrivalent ion selected from the group consisting of Ti⁴⁺, Ge⁴⁺, Sn⁴⁺, and V⁴⁺; and R is a pentavalent ion selected from the group consisting of V⁵⁺, Nb⁵⁺, and Ta⁵⁺.

The electrode potential of the lithium-containing compound having the olivine structure varies depending on the kind of the metal element M. This allows the battery voltage to be arbitrarily determined by selecting the kind of the metal element M.

The lithium-containing compound having the olivine structure may be lithium iron phosphate (LiFePO₄). This allows the fabrication cost of the non-aqueous electrolyte secondary battery to be reduced, since iron compounds for use as the raw materials of lithium iron phosphate (LiFePO₄) are readily available and inexpensive.

It is preferred that the proportion of the copolymer to the positive electrode mixture is not less than 1% by weight and not more than 15% by weight. Setting the proportion of the copolymer to the positive electrode mixture to not less than 1% by weight and not more than 15% by weight allows the energy density to be increased while maintaining the shape of the positive electrode.

It is preferred that the lithium-containing compound having the olivine structure has a particle size of not more than 10 μm. A particle size of not more than 10 μm reduces the diffusion length of lithium in the particles, thereby reducing the resistance involving the elimination and insertion of lithium during charge and discharge. This allows the utilization of most of the active material particles. As a result, the charge/discharge characteristics can be improved. Moreover, a particle size of not more than 10 μm ensures a sufficient contact area between the particles and the conducting agent. This improves the conductivity of the positive electrode, thereby improving the load characteristic.

It is preferred that the lithium-containing compound having the olivine structure has a particle size of not more than 5 μm. This further reduces the diffusion length of lithium in the particles, so as to ensure a reduction in the resistance involving the elimination and insertion of lithium during charge and discharge. Thus, the utilization of the active material particles can be further improved. This results in further improved charge/discharge characteristics. Moreover, the contact area between the particles and the conducting agent is ensured, leading to reliable improvements in the electron conductivity of the positive electrode and the load characteristic.

It is preferred that the proportion of the conducting agent to the positive electrode mixture is not more than 10% by weight. Too great an amount of added conducting agent reduces the proportion of the positive electrode active material in the positive electrode mixture, making it impossible to obtain a high capacity. Thus, setting the proportion of the conducting agent to the positive electrode mixture to not more than 10% by weight results in improved current collection capability in the positive electrode mixture without lowering the capacity.

The non-aqueous electrolyte secondary battery according to the invention allows increased capacity and increased energy density as well as good discharge characteristics during discharge at high rate, by the inclusion of the lithium-containing compound having the olivine structure as the positive electrode active material and the inclusion of polyvinylidene fluoride, tetrafluoroethylene, and hexafluoropropylene as a binder.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram of a test cell that is fabricated in Inventive Example.

### DESCRIPTION OF THE PREFERRED EMBODIMENTS

A non-aqueous electrolyte secondary battery according to an embodiment of the invention will be described below.

A non-aqueous electrolyte secondary battery according to the embodiment comprises a positive electrode, a negative electrode, and a non-aqueous electrolyte.

The positive electrode comprises a positive electrode mixture and a current collector, wherein the positive electrode mixture includes a positive electrode active material, a binder, and a conducting agent.

A lithium-containing compound having an olivine structure is used as the positive electrode active material. The lithium-containing compound as used here is a compound having an olivine crystalline structure represented by a general formula; LiₓM_{1-(d+t+q+r)}D_{d}TₜQ_{q}Rᵣ(XO₄) that satisfies relationships of 0<x≦1; 0≦d≦1; 0≦t≦1; 0≦q≦1; and 0≦r≦1, where M is at least one selected from the metal elements including iron (Fe), manganese (Mn), cobalt (Co), titanium (Ti), and nickel (Ni), for example; X is at least one selected from the metal elements including silicon (Si), sulfur (S), phosphorus (P), and vanadium (V), for example; D is a bivalent ion selected from Mg²⁺, Ni²⁺, Co²⁺, Zn²⁺, and Cu²⁺, for example; T is a trivalent ion selected from Al³⁺, Ti³⁺, Cr³⁺, Fe³⁺, Mn 3+, Ga³⁺, Zn³⁺, and V³⁺, for example; Q is a quadrivalent ion selected from Ti⁴⁺, Ge⁴⁺, Sn⁴⁺, and V⁴⁺, for example; and R is a pentavalent ion selected from V⁵⁺, Nb⁵⁺, and Ta⁵⁺, for example.

The electrode potential of the lithium-containing compound having the above-described olivine structure varies depending on the kind of the metal element M. Thus, the battery voltage can be arbitrarily selected by selecting the kind of the metal element M.

Representative lithium-containing compounds having the olivine structure include LiFePO₄, LiCoPO₄, and the like. As an example, Li_{0.90}Ti_{0.05}Nb_{0.05}Fe_{0.30}Co_{0.30}Mn_{0.30}PO₄ is also a lithium-containing compound having the olivine structure. LiFePO₄, in particular, is preferable, since iron compounds for use as its raw materials are readily available and inexpensive.

Transition metals such as cobalt (Co), nickel (Ni), manganese (Mn), and the like other than iron (Fe) may also be used as M in the aforementioned general formula. The resultant lithium-containing compound has a similar crystalline structure to that of the case using iron (Fe) as M in the general formula, and therefore expected to provide similar effects as a positive electrode active material.

The particle size of the lithium-containing compound having the olivine structure is preferably not more than 10 μm, more preferably not more than 5 μm, for both the median diameter (R_{median}) and mode diameter (R_{mode}), when measured with a laser diffraction particle size distribution analyzer.

In the lithium-containing compound having the olivine structure, lithium is slow in elimination and insertion reactions during charge and discharge. For this reason, when the particle size is too large, the resistance involving the elimination and insertion of lithium is increased, making it impossible to use the center of particles as an active material.

In contrast, a particle size of not more than 10 μm reduces the diffusion length of lithium inside the particles, thereby reducing the resistance involving the elimination and insertion of lithium during charge and discharge. Thus, when the lithium-containing compound having the olivine structure is used as the positive electrode active material, a particle size of not more than 10 μm improves the utilization of the active material particles, and a particle size of not more than 5 μm further improves the utilization. This results in improved charge/discharge characteristics. Moreover, a particle size of not more than 10 μm ensures a sufficient contact area between the particles and the conducting agent, and a particle size of not more than 5 μm further increases the contact area. This results in an improved electron conductivity of the positive electrode, and improved load characteristic.

A mixture of the lithium-containing compound having the olivine structure and another positive electrode material may also be used as the positive electrode active material.

For example, a conducting carbon material or a metal oxide is used as the conducting agent, preferably conducting carbon powder is used. Mixing the conducting agent into the positive electrode active material causes the conducting agent to form a conducting network around the particles of the positive electrode active material. This improves the electron conductivity in the positive electrode mixture. Note that too great an amount of added conducting agent reduces the proportion of the positive electrode active material in the positive electrode mixture, making it impossible to obtain a high capacity. Therefore, the amount of added conducting agent is preferably not more than 10% by weight of the entire positive electrode mixture.

The binder is composed of a copolymer including vinylidene fluoride (VDF), tetrafluoroethylene (TEF), and hexafluoropropylene (HFP). This increases the packing density of the positive electrode active material and the conducting agent in the positive electrode mixture. This allows improved adhesion between the positive electrode active material and the conducting agent, between the conducting agent and the current collector, and between the current collector and the positive electrode active material, thereby improving the electron conductivity of the positive electrode mixture even when using the lithium-containing compound having the olivine structure with low electron conductivity as the positive electrode active material.

This results in improved load characteristic of the positive electrode, and improved discharge characteristics during discharge at high rate. The packing density of the positive electrode also increases to prevent a reduction in the energy density even when using a positive electrode active material with a small particle size. This enables increases in the capacity and energy density of the non-aqueous electrolyte secondary battery.

Note that a small amount of added binder makes it impossible to maintain the shape of the positive electrode, whereas too great an amount of added binder prevents a high energy density. Therefore, the amount of added binder is preferably not less than 1% by weight and not more than 15% by weight of the entire positive electrode mixture.

In order to increase the electron conductivity, aluminum foam, nickel foam or the like may be used as the current collector of the positive electrode.

In this embodiment, it is preferred that the positive electrode is formed by rolling the sufficiently dried positive electrode mixture on the current collector. A reduction roller, a press or the like may be used for rolling. By rolling the positive electrode mixture in this way, the density of the positive electrode active material can be increased. This enables an improvement in the volume energy density of the positive electrode active material. Rolling also increases the contact area between the positive electrode active material and the conducting agent, thereby improving the electron conductivity of the positive electrode mixture, and improving the load characteristic.

A carbon material such as graphite that can occlude and release lithium (Li), a lithium metal, or a lithium alloy, for example, may be used as the negative electrode.

In order to obtain a non-aqueous electrolyte secondary battery with high energy density, silicon having a large capacity is desirable for use as the negative electrode. As suggested in JP 2001-266851 A and JP 2002-83594 A (or WO01/029912), in particular, a silicon negative electrode employing foil with a roughened surface for the current collector, a silicon negative electrode having a columnar structure, a silicon negative electrode in which copper (Cu) is diffused, or a silicon negative electrode having at least one characteristic of those mentioned above is preferable for use.

A non-aqueous electrolyte that includes an electrolytic salt dissolved in a non-aqueous solvent may be used as the non-aqueous electrolyte.

The non-aqueous solvent may include those for use in general batteries such as cyclic carbonic esters, chain carbonic esters, esters, cyclic ethers, chain ethers, nitrils, amides, and the like.

Cyclic carbonic esters include ethylene carbonate, propylene carbonate, butylene carbonate, and the like. Those in which a portion of or the entire hydrogen group is fluorinated may also be used, such as trifluoropropylene carbonate, fluoroethyl carbonate, and the like, for example.

Chain carbonic esters include dimethyl carbonate, ethyl methyl carbonate, diethyl carbonate, methyl propyl carbonate, ethyl propyl carbonate, methyl isopropyl carbonate, and the like. Those in which a portion of or the entire hydrogen group is fluorinated may also be used.

Esters include methyl acetate, ethyl acetate, propyl acetate, methyl propionate, ethyl propionate, γ-butyrolactone, and the like. Cyclic ethers include 1,3-dioxolane, 4-methyl-1,3-dioxolane, tetrahydrofuran, 2-methyl tetrahydrofuran, propylene oxide, 1,2-butylene oxide, 1,4-dioxane, 1,3,5-trioxane, furan, 2-methylfuran, 1,8-cineole, crown ether, and the like.

Chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butyl phenyl ether, pentyl phenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyetane, triethylene glycol dimethyl ether, tetraethylene glycol dimethyl ether, and the like.

Nitrils include acetonitril and the like. Amides include dimethylformamide and the like.

Among the above-mentioned non-aqueous solvents, it is preferred to use a cyclic carbonic ester such as ethylene carbonate and propyl carbonate or a chain carbonic ester such as dimethyl carbonate, diethyl carbonate, and dipropyl carbonate, particularly in terms of voltage stability.

Electrolytic salts include LiPF₆, LiAsF₆, LiBF₄, LiCF₃SO₃, LiN(CₖF₂ₖ₊₁SO₂) (CₘF₂ₘ₊₁SO₂) (where k and m are integers not less than one), LiC(CₚF₂ₚ₊₁SO₂) (C_{q}F_{2q+1}SO₂) (CᵣF₂ᵣ₊₁SO₂) (where p, q, r are integers not less than one), and difluoro (oxalato) lithium borate represented in the structural formula below:

[chemical formula 1]

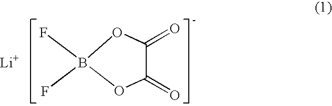

A combination of one or more of the above-mentioned electrolytic salts may also be used.

The above-mentioned electrolytic salt is dissolved in the above-mentioned non-aqueous solvent at a concentration of 0.1 to 1.5 mol/l, preferably at a concentration of 0.5 to 1.5 mol/l, when used.

As described above, the non-aqueous electrolyte secondary battery according to the embodiment allows increased capacity and energy density as well as good discharge characteristics during discharge at high rate. In addition, using lithium iron phosphate (LiFePO₄) as the positive electrode active material, in particular, the cost can be reduced.

### EXAMPLES

It will be demonstrated through Examples that using a copolymer of polyvinylidene fluoride (VDF), tetrafluoroethylene (TFE), and hexafluoropropylene (HFP) as a binder of the positive electrode mixture of a non-aqueous electrolyte secondary battery, good discharge characteristics can be obtained even during discharge at high rate.

Note that the non-aqueous electrolyte secondary battery according to the invention should not be limited by that shown in Inventive Example below, and suitable modifications may be made to implement the non-aqueous electrolyte secondary battery within the gist of the invention

### Inventive Example

(Fabrication of Positive Electrode)

A positive electrode in Inventive Example was fabricated as follows.

Lithium iron phosphate (LiFePO₄) as a positive electrode active material and acetylene black (Denka Black manufactured by Denki Kagaku Kogyo) as a conducting agent were mixed first. A copolymer of polyvinylidene fluoride (VDF), tetrafluoroethylene (TFE), and hexafluoropropylene (HFP) was then added as a binder to the mixture, followed by the addition of an appropriate amount of N-methyl-2-pyrrolidone (NMP) to the mixture to prepare a slurry. The weight ratio of lithium iron phosphate, the conducting agent, and the binder was 90:5:5.

The slurry was applied as a positive electrode mixture onto a piece of aluminum foil having a roughed surface as a current collector by the doctor blade technique, and then dried at 80° C. with a hotplate. A 2×2 cm square was subsequently cut from the current collector coated with the positive electrode mixture, and the piece was rolled with a roller and dried at 100° C. under vacuum. The positive electrode was thus fabricated.

(Fabrication of Negative Electrode)

Lithium metal cut into a predetermined size was used as the negative electrode.

(Preparation of Non-Aqueous Electrolyte)

A non-aqueous solvent obtained by mixing ethylene carbonate and diethyl carbonate at a volume ratio of 50:50 was used as a non-aqueous electrolyte with the addition of lithium hexafluorophosphate (LiPF₆) in a concentration of 1.0 mol/l.

(Fabrication of Reference Electrode)

Lithium metal cut into a predetermined size was used as the reference electrode.

(Fabrication of Test Cell)

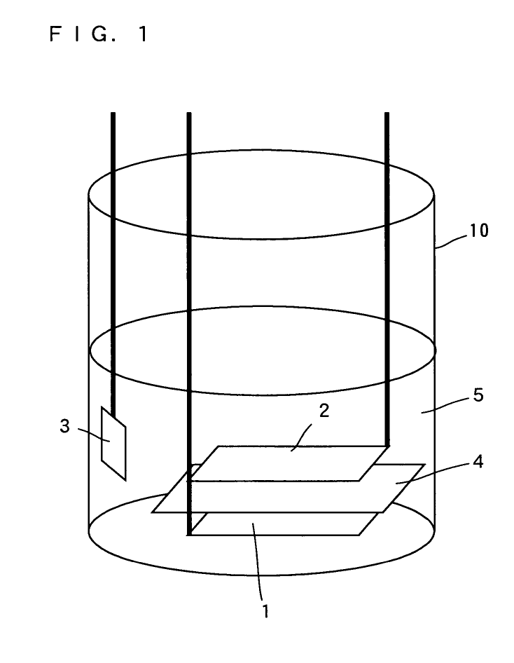

FIG. 1 is a schematic diagram of a test cell fabricated in Inventive Example. As shown in FIG. 1, leads were attached to the above-described positive electrode 1 and negative electrode 2, respectively, under an inert atmosphere. A separator 4 was inserted between the positive electrode 1 and the negative electrode 2, and then the positive electrode 1, negative electrode 2, and reference electrode 3 were arranged inside a test cell vessel 10. The above-described non-aqueous electrolyte 5 was poured into the test cell vessel 10 to fabricate the test cell in Inventive Example.

### Comparative Example

In Comparative Example, a test cell similar to that of Inventive Example was fabricated except using polyvinylidene fluoride (PVdF) as a binder.

(Evaluation)

Using the test cells in Inventive Example and Comparative Example, charge/discharge tests were performed under the following conditions for measuring the discharge capacities per unit mass of their respective positive electrode active materials. Note that the following conditions include setting the rated current to 1.0 C. The rated current as mentioned here represents a current value at which a rated discharge capacity is completely discharged in an hour, and the rated discharge capacity represents a virtual discharge capacity that is estimated by the weight of the positive electrode active material and the area of the positive electrode mixture.

During the 1st cycle, the test cells were charged and discharge data current value of ( 1/10) C. During the subsequent 2nd to 6th cycles, the test cells were charged and discharged at a current value of (⅕) C. During the 7th cycle, the test cells were charged at a current value of (⅕) C, and discharged at a current value of (½) C. During the 8th cycle, the test cells were charged at a current value of (⅕) C, and discharged at a current value of 1 C. During the 9th cycle, the test cells were charged at a current value of (⅕) C, and discharged at a current value of 2 C. Note that the charge cutoff voltage was 4.5 V, and the discharge cutoff voltage was 2 V.

Table 1 shows the comparisons of discharge capacities at the respective discharge current values. The discharge capacities at a discharge current of (⅕) C show measurements of the discharge capacities during the 6th cycle.

TABLE 1

| | | | Inventive | Comparative |
|---|---|---|---|---|
| | | | Example | Example |
| Discharge | (1/10) | C | 142.1 | 142.5 |
| Capacity Per | (1/5) | C | 133.6 | 131.3 |
| Unit Mass Of | 1 | C | 120.9 | 116.1 |
| Positive | 2 | C | 110.0 | 93.2 |
| Electrode | | | | |
| Active | | | | |
| Material | | | | |
| (mAh/g) | | | | |

As shown in Table 1, for discharge at ( 1/10) C, there is no great difference between the discharge capacities in Inventive Example and Comparative Example. On the other hand, for discharge at (⅕) C, 1 C, and 2 C, the discharge capacities in Inventive Example were higher than those in Comparative Example. For discharge at a high rate of 2 C, in particular, the discharge capacity in Inventive Example was sufficiently higher than that in Comparative Example.

In Inventive Example, the use of the copolymer of polyvinylidene fluoride (VDF), tetrafluoroethylene (TFE), and hexafluoropropylene (HFP) as a binder increased the packing densities of the positive electrode active material and the conducting agent in the positive electrode mixture, so as to improve the adhesion between the positive electrode active material and the conducting agent, between the conducting agent and the current collector, and between the current collector and the positive electrode active material, resulting in improved discharge characteristics at high rate.

As described above, the use of the copolymer of polyvinylidene fluoride (VDF), tetrafluoroethylene (TFE), and hexafluoropropylene (HFP) results in the fabrication of a non-aqueous electrolyte secondary battery having good discharge characteristics even during discharge at high rate.

It is desired that the positive electrode active material is not less than 75% by weight of the entire positive electrode mixture, the conducting agent is not more than 10% by weight of the positive electrode mixture, and the binder is not more than 15% by weight of the entire positive electrode mixture. The use of the binder including polyvinylidene fluoride (VDF), tetrafluoroethylene (TFE), and hexafluoropropylene (HFP) as in this invention allows improved packing density of the positive electrode mixture. When the positive electrode active material is not less than 90% by weight, the conducting agent is not more than 5% by weight, and the binder is not more than 5% by weight, of the entire positive electrode mixture, the effects of the invention become all the more evident. Furthermore, even when the binder makes up only a small proportion of the entire positive electrode mixture, the invention still provides good discharge characteristics during discharge at high rate.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A non-aqueous electrolyte secondary battery comprising a positive electrode mixture, a negative electrode, and a non-aqueous electrolyte, wherein
said positive electrode mixture includes a positive electrode active material that includes a lithium-containing compound having an olivine structure, a conducting agent, and a binder, and
said binder includes a copolymer of polyvinylidene fluoride, tetrafluoroethylene, and hexafluoropropylene.

2. The non-aqueous electrolyte secondary battery according to claim 1, wherein
said lithium-containing compound having said olivine structure is represented by LiₓM_{1-(d+t+q+r)}D_{d}TₜQ_{q}Rᵣ(XO₄), where said x, d, t, q, and r satisfy relationships of 0<x≦1; 0≦d≦1; 0≦t≦1; 0≦q≦1; and 0≦r≦1, respectively; said M is at least one selected from the group consisting of iron, manganese, cobalt, titanium, and nickel; said X is at least one selected from the group consisting of silicon, sulfur, phosphorus, and vanadium; said D is a bivalent ion selected from the group consisting of Mg²⁺, Ni²⁺, Co²⁺, Zn 2+, and Cu²⁺; said T is a trivalent ion selected from the group consisting of Al³⁺, Ti³⁺, Cr³⁺, Fe³⁺, Mn³⁺, Ga³⁺, Zn³⁺, and V³⁺; said Q is a quadrivalent ion selected from the group consisting of Ti⁴⁺, Ge 4+, Sn⁴⁺, and V⁴⁺; and said R is a pentavalent ion selected from the group consisting of V⁵⁺, Nb⁵⁺, and Ta⁵⁺.

3. The non-aqueous electrolyte secondary battery according to claim 1, wherein
said lithium-containing compound having said olivine structure is lithium iron phosphate.

4. The non-aqueous electrolyte secondary battery according to claim 1, wherein
the proportion of said copolymer to said positive electrode mixture is not less than 1% by weight and not more than 15% by weight.

5. The non-aqueous electrolyte secondary battery according to claim 1, wherein
said lithium-containing compound having said olivine structure has a particle size of not more than 10 μm.

6. The non-aqueous electrolyte secondary battery according to claim 1, wherein
said lithium-containing compound having said olivine structure has a particle size of not more than 5 μm.

7. The non-aqueous electrolyte secondary battery according to claim 1, wherein
the proportion of said conducting agent to said positive electrode mixture is not more than 10% by weight.
